(19) United States
(12) Patent Application Publication
(10) Pub. No.: US 2026/0251931 A1
(43) Pub. Date: Aug. 27, 2026

(54) LCOS DEVICE

(71) Applicant: OmniVision Technologies, Inc., Santa Clara, CA (US)

(72) Inventors: Chun-Sheng Fan, Zhudong Township (TW); Fei Li, Shenzhen (CN); Pei-Wen Ko, Taipei (TW); Wei-Feng Lin, Hsinchu City (TW)

(21) Appl. No.: 19/063,792

(22) Filed: Feb. 26, 2025

(51) Int. Cl. G02F 1/1333; G02F 1/136

(52) U.S. Cl. CPC G02F 1/133382; G02F 1/13613; G02F 2202/10

(57) ABSTRACT

A liquid-crystal-on-silicon device includes a substrate, a thermally-conductive layer, an LCOS display panel, a printed circuit layer, and a resistive heating element. The thermally-conductive layer is on the substrate and has a thermally-conductive central region surrounded by a thermally-conductive periphery region. The LCOS display panel is on the thermally-conductive central region. The printed circuit layer is on the thermally-conductive periphery region and at least partially surrounding the LCOS display panel. The resistive heating element is electrically connected to the printed circuit layer, thermally connected to the thermally-conductive periphery region. At least part of the resistive heating element is directly above or directly below the thermally-conductive periphery region.

### BACKGROUND

Liquid Crystal on Silicon (LCOS) is a technology commonly used to generate projected images, wherein liquid crystals within a LCOS display panel are controlled to affect reflectivity of light impinging onto a pixelated area, such that the reflected light forms a desired image. LCOS devices are becoming popular for use in projection televisions, for example. However, when the temperature is below a predefined temperature (e.g., seventy degrees Celsius), the liquid crystals are slow to respond to electrical changes, and performance (e.g., color rendering) of the LCOS display panel is not optimal.

One method of heating an LCOS panel is via a heating element incorporated into a substrate of the LCOS panel itself. However, positioning the heating element within the silicon substrate of the LCOS panel limits the voltage and power that may be applied to the heating element. For example, using high voltage/current and/or high heat dissipation within the silicon substrate of the LCOS panel may result in electrical interference with display operation and/or thermal damage to the silicon substrate. Thus, the temperature regulation achieved by this design is poor.

### SUMMARY OF THE EMBODIMENTS

Embodiments disclosed herein provide heat to an LCOS panel while avoiding the problems of the existing method described above.

In a first aspect a liquid-crystal-on-silicon device includes a substrate, a thermally-conductive layer, an LCOS display panel, a printed circuit layer, and a resistive heating element. The thermally-conductive layer is on the substrate and has a thermally-conductive central region surrounded by a thermally-conductive periphery region. The LCOS display panel is on the thermally-conductive central region. The printed circuit layer is on the thermally-conductive periphery region and at least partially surrounding the LCOS display panel. The resistive heating element is electrically connected to the printed circuit layer, thermally connected to the thermally-conductive periphery region. At least part of the resistive heating element is directly above or directly below the thermally-conductive periphery region.

### BRIEF DESCRIPTION OF THE FIGURES

FIG. 1 is a system diagram of an LCOS device, in an embodiment.

FIG. 2 is an isometric view of a first LCOS device, which is an example of the LCOS device of FIG. 1.

FIG. 3A is an isometric view of a portion of the LCOS device of FIG. 2.

FIG. 3B is a cross-sectional view a portion of the LCOS device of FIG. 3A.

FIG. 4 is an isometric view of a portion of the LCOS device of FIG. 3A.

FIGS. 5A, 5B, 5C, 6, and 7 are schematics of a second LCOS device, which is an example of the LCOS device of FIG. 1.

FIGS. 8A, 8B, 8C, 9, and 10 are schematics of a third LCOS device, which is an example of the LCOS device of FIG. 1.

### DETAILED DESCRIPTION OF THE EMBODIMENTS

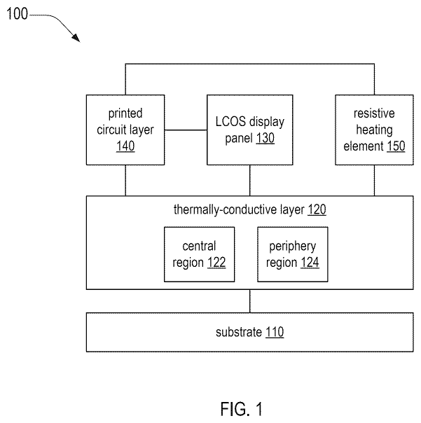

FIG. 1 is a system diagram of an LCOS device 100, which includes a substrate 110, a thermally-conductive layer 120, an LCOS display panel 130, a printed circuit layer 140, and a heating element 150. Thermally-conductive layer 120 is on substrate 110 and has a thermally-conductive central region 122 surrounded by a thermally-conductive periphery region 124. LCOS display panel 130 is on thermally-conductive central region 122. Printed circuit layer 140 is on thermally-conductive periphery region 124 and at least partially surrounds LCOS display panel 130.

A material composition of substrate 110 may include aluminum nitride, aluminum oxide, stainless steel, aluminum, copper, or any combination thereof. Thermally-conductive layer 120 may have a thermal conductivity exceeding 1 W/mK and have a material composition that includes graphene. Thermally-conductive layer 120 may be one of a thermal paste, a thermal adhesive, a thermally conducive pad, a phase-change material, and a metal thermal interface material. Printed circuit layer 140 may be a flexible printed circuit layer. Heating element 150 may be a resistive heating element, such as a positive-temperature-coefficient thermistor.

Heating element 150 is electrically connected to printed circuit layer 140 and is thermally connected to thermally-conductive periphery region 124. At least part of heating element 150 is directly above or directly below thermally-conductive periphery region 124. Heating element 150 may be surface mounted to printed circuit layer 140.

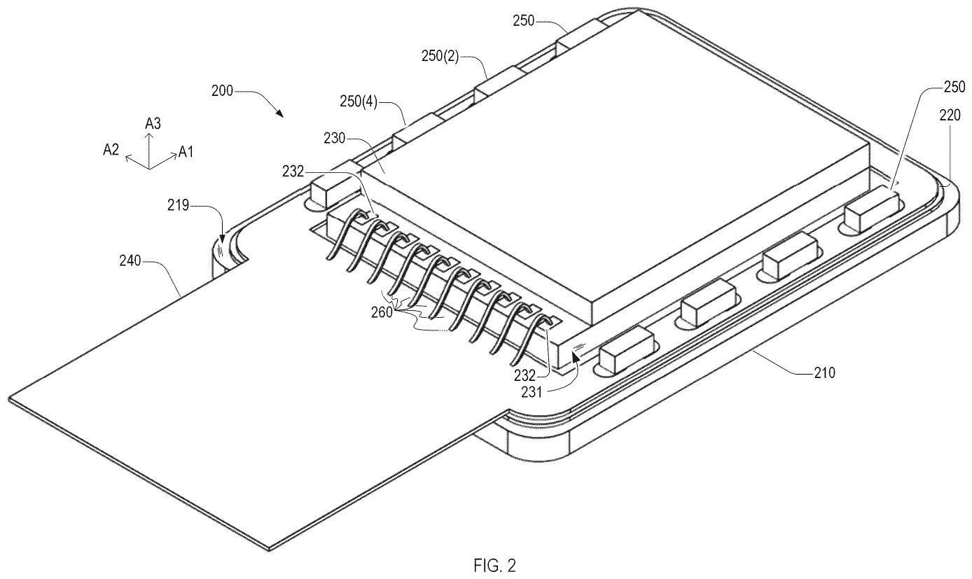

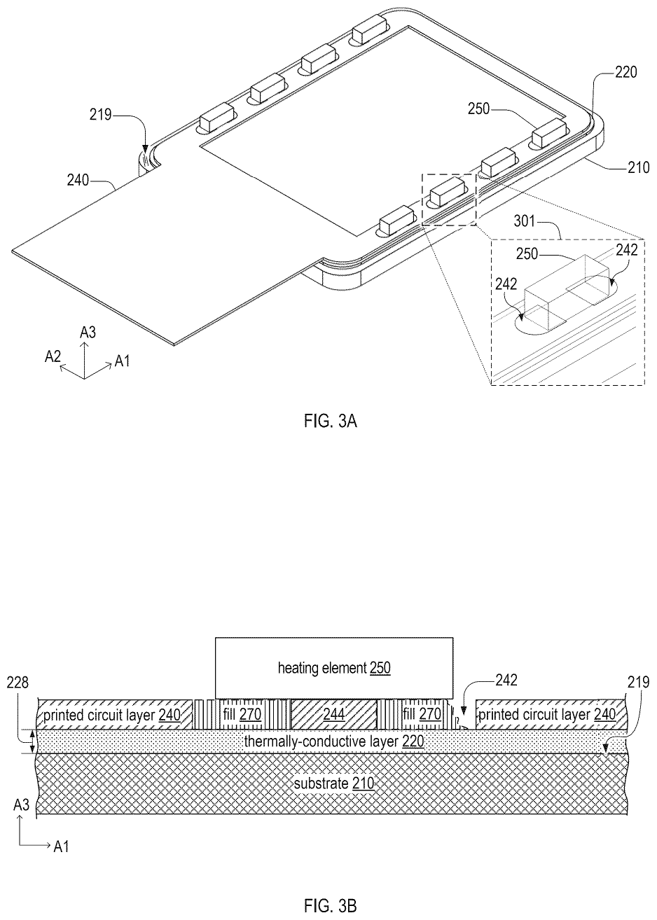

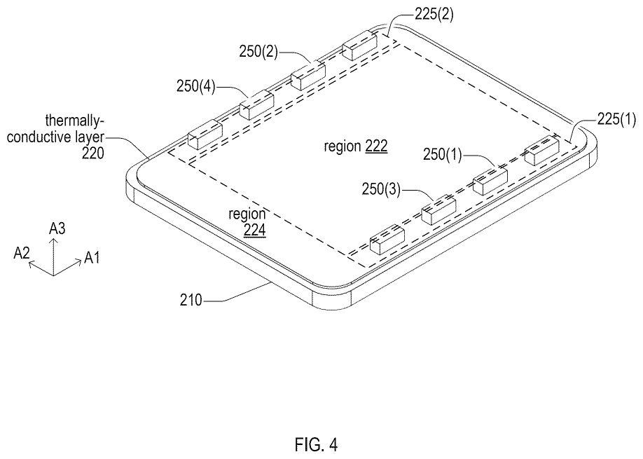

FIG. 2 is a schematic of an LCOS device 200, which is an embodiment of LCOS device 100. FIGS. 3A, 3B, and 4 are schematics of selected components of LCOS device 200. FIGS. 2-4 are best viewed together in the following description. Figures herein depict orthogonal axes A1, A2, and A3. Unless otherwise specified, heights and depths of objects herein refer to the object's extent along axis A3. Also, herein, a horizontal plane is parallel to the A1-A2 plane, a width refers to an object's extent along axis A1 or axis A2, and a vertical direction is along axis A3.

LCOS device 200 includes a substrate 210, a thermally-conductive layer 220, an LCOS display panel 230, a printed circuit layer 240, and a heating element 250, which are respective examples of substrate 110, thermally-conductive layer 120, LCOS display panel 130, printed circuit layer 140, and heating element 150 of LCOS device 100. LCOS device 200 may include multiple heating elements 250, as shown in FIGS. 2-4. While FIGS. 2-4 denote eight heating elements 250, LCOS device 200 may include a different number of heating elements 250 without departing from the scope hereof.

Substrate 210 has a top surface 219, which may be parallel to the A1-A2 plane. Thermally-conductive layer 220 is on top surface 219 and has a central region 222 surrounded on all four sides by a periphery region 224, as shown in FIG. 4. Periphery region 224 includes sections 225(1) and 225(2). Thermally-conductive layer 220 has a thickness 228 along axis A3. Thickness 228 may be between ten micrometers and one hundred micrometers.

Regions 222 and 224 are respective examples of regions 122 and 124. In LCOS device 200, LCOS display panel 230 and heating element 250 are on a same side of substrate 210, namely the side proximate top surface 219.

FIG. 3A is an isometric view of a portion of LCOS device 200 and includes an inset 301 showing a region of LCOS device 200 that includes one heating element 250 on printed circuit layer 240. Heating element 250 may be surface mounted to printed circuit layer 240.

FIG. 3B is a cross-sectional view of the part of LCOS device 200 shown in inset 301. The cross-sectional plane of FIG. 3B is perpendicular to top surface 219 and parallel to the A1-A3 plane. At least part of heating element 250 may be above one or more apertures 242 in printed circuit layer 240. In the example of FIGS. 3A and 3B, heating element 250 is above two apertures 242 and is on a bridge region 244 of printed circuit layer 240, which is shown in FIG. 3B. In FIG. 3B, (i) heating element 250 is entirely above thermally-conductive periphery region 224 and (ii) both thermally-conductive periphery region 224 and bridge region 244 are between heating element 250 substrate 210. Also in FIG. 3B, heating element 250 and thermally-conductive layer 220 are on opposite sides of printed circuit layer 240.

LCOS device 200 may include a thermally conductive fill 270 in aperture 242 that thermally couples heating element 250 to thermally-conductive periphery region 224. In FIG. 3B, part of conducive fill 270 is cut away to illustrate aperture 242. Examples of thermally conductive fill 270 include thermal paste and thermal glue.

FIG. 4 is an isometric view of a portion of the LCOS device of FIG. 3A. LCOS display panel 230 has a lateral surface 231 that is parallel to the A1-A3 plane as shown in FIG. 2. FIG. 4 denotes a section 225(1) of thermally-conductive periphery region 224 that is adjacent to lateral surface 231. In embodiments, LCOS device 200 includes multiple resistive heating elements 250. One or more heating elements 250 may be most proximate to section 225(1), as illustrated by heating elements 250(1) and 250(3) shown in FIG. 4. One or more additional heating elements 250 may be most proximate to section 225(2) of thermally-conductive periphery region 224 that is adjacent to a second lateral surface, of LCOS display panel 230, that differs from lateral surface 231. For example, LCOS device 200 may include one or both of heating elements 250(2) and 250(4).

LCOS device 200 may also include a plurality of wires 260, each of which electrically connect a respective bond pad 232 of LCOS display panel 230 to a respective address electrode of printed circuit layer 240. One or more of bond pads 232 and wires 260 may be arrayed in a direction that is nonparallel to surface 231. For example, wires 260 may be arrayed in a direction parallel to axis A2 and surface 231 may be parallel to the A1-A3 plane. For clarity of illustration, not all wires 260 and bond pads 232 are labeled in FIG. 2.

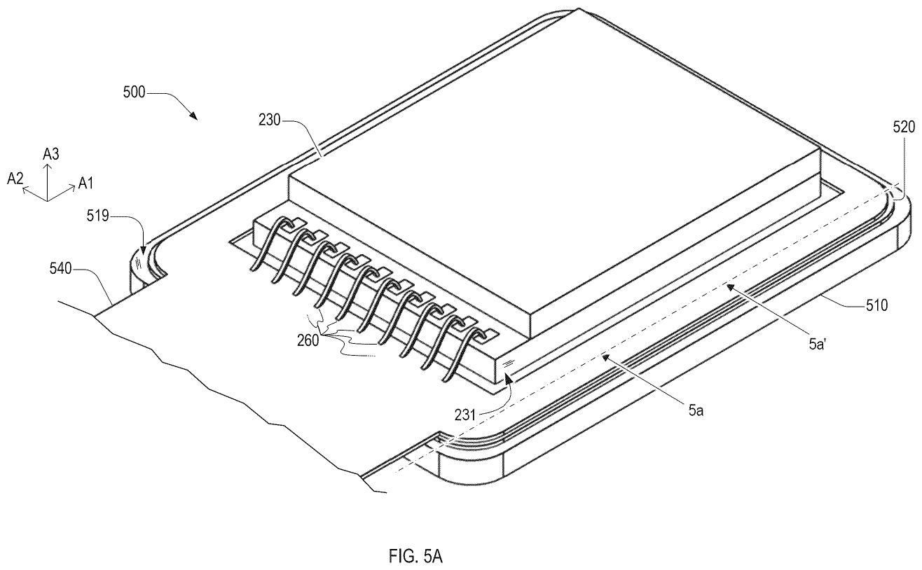

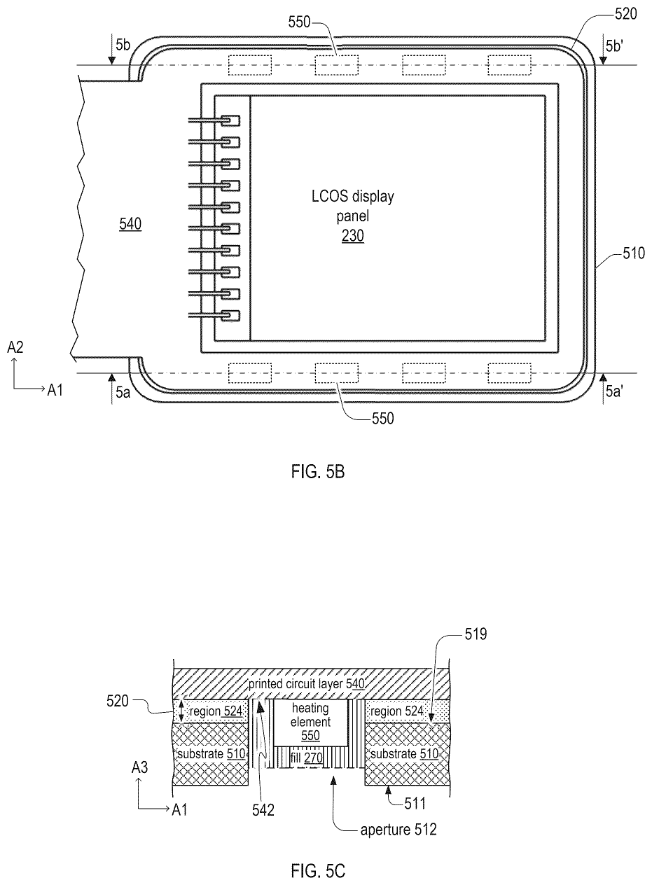

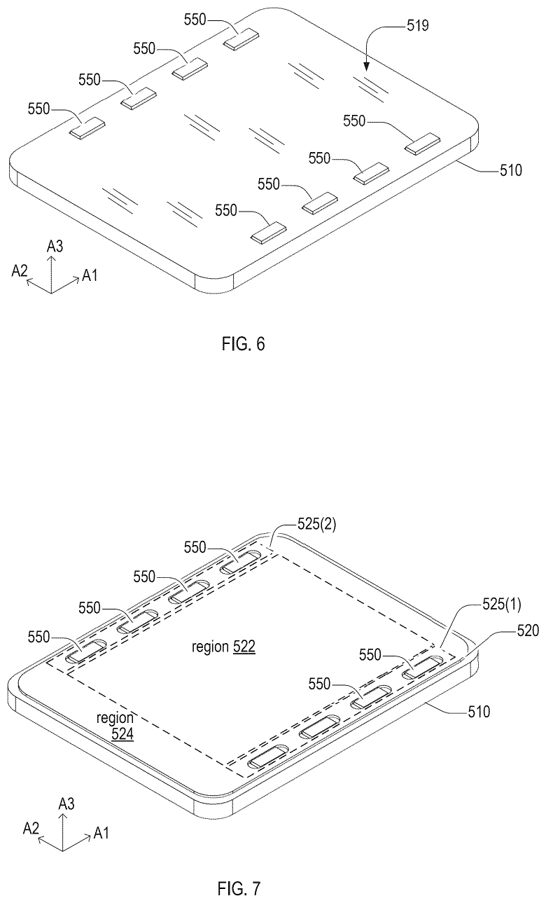

FIG. 5A is an isometric view of an LCOS device 500, which is an embodiment of LCOS device 100. FIG. 5B is a plan view of LCOS device 500 that denotes cross-sectional planes 5a-5a′ and 5b-5b′, each of which is parallel to the A1-A3 plane. FIG. 5C is a cross-sectional view of part of LCOS device 500 in either of cross-sectional planes 5a-5a′ and 5b-5b′. FIGS. 6 and 7 are schematics of selected components of LCOS device 500. FIGS. 5A, 5B, 5C, 6, and 7 are best viewed together in the following description.

LCOS device 500 includes a substrate 510, a thermally-conductive layer 520, a printed circuit layer 540, and at least one heating element 550, which are respective examples of substrate 110, thermally-conductive layer 120, printed circuit layer 140, and heating element 150 of LCOS device 100. LCOS device 500 also includes LCOS display panel 230. The cross-sectional view of FIG. 5C includes part of LCOS device 500 that includes a heating element 550.

FIG. 5A does not illustrate heating elements 550, as in the example of FIG. 5A, heating elements 550 are covered by printed circuit layer 540. Without departing from the scope hereof, circuit layer 540 may include apertures that expose part of heating elements 550. Since FIG. 5B is a plan view, heating elements 550 are not visible in FIG. 5B. However, for illustrative purposes, the locations of heating elements 550 are shown as dashed boxes. For clarity of illustration, not all heating elements 550 are labeled in FIG. 5B. While FIG. 5B denotes eight heating elements 550, LCOS device 500 may include a different number of heating elements 550 without departing from the scope hereof.

Thermally-conductive layer 520 has a central region 522 surrounded by a periphery region 524, as shown in FIG. 7. Regions 522 and 524 are respective examples of regions 122 and 124. Periphery region 524 includes sections 525(1) and 525(2), which are similar to sections 225(1) and 225(2) of periphery region 224. Thermally-conductive layer 520 has a thickness 228 along axis A3. One or more of cross-sectional planes 5a-5a′ and 5b-5b′ intersects a heating element 550, as shown in FIG. 5C.

Substrate 510 has a top surface 519, a bottom surface 511 opposite top surface 519, and includes one or more apertures 512, as shown in FIG. 5C. Each aperture 512 extends? between a top surface 519 and bottom surface 511. At least one of surfaces 511 and 519 is parallel to the A1-A2 plane. Top surface 519 is an example of top surface 219. FIG. 6 shows parts of heating elements 550 that extend above a plane of top surface 519.

Each aperture 512 exposes a respective surface region 542 of printed circuit layer 540. At last part of each heating element 550 is within a respective aperture 512 and is electrically connected to printed circuit layer 540 at the printed circuit layer-surface region 542 exposed by the respective aperture 512. LCOS device 500 may include, in at least one of apertures 512, thermally conductive fill 270 that thermally couples the heating element 550 to thermally-conductive layer 520. Part of heating element 550 may be coplanar with thermally-conductive periphery region 524, as shown in FIG. 5C. Without departing from the scope hereof, at least part of heating element 550 may entirely below a plane of thermally-conductive periphery region 524. In embodiments, heating element 550 and thermally-conductive layer 520 (region 524) are the same side of printed circuit layer 540, as shown in FIG. 5C.

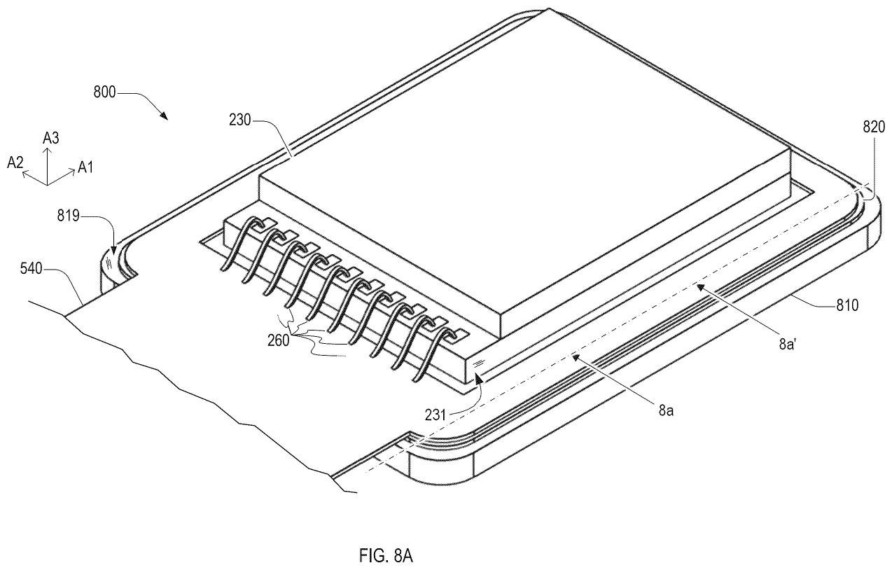

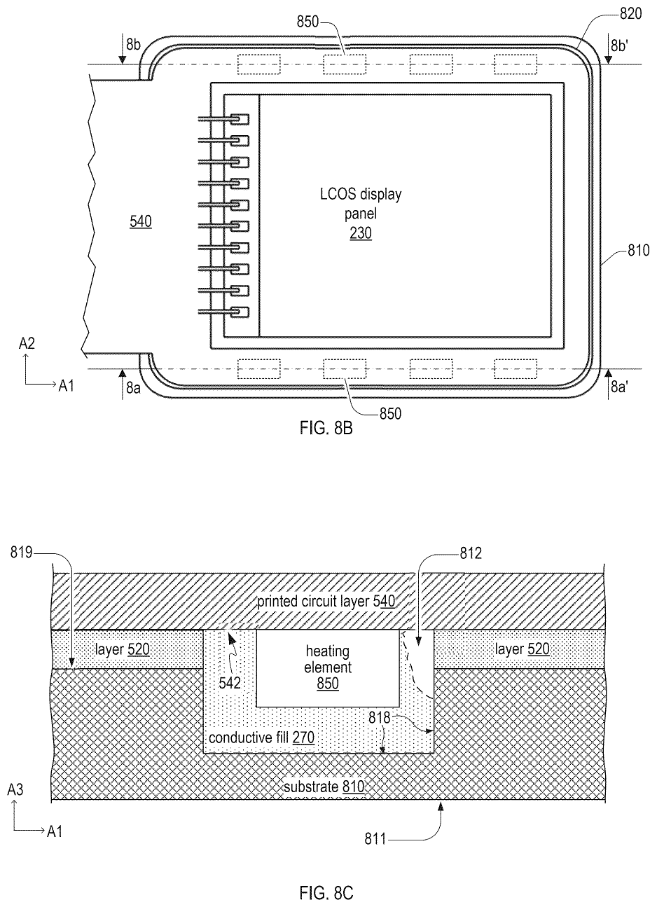

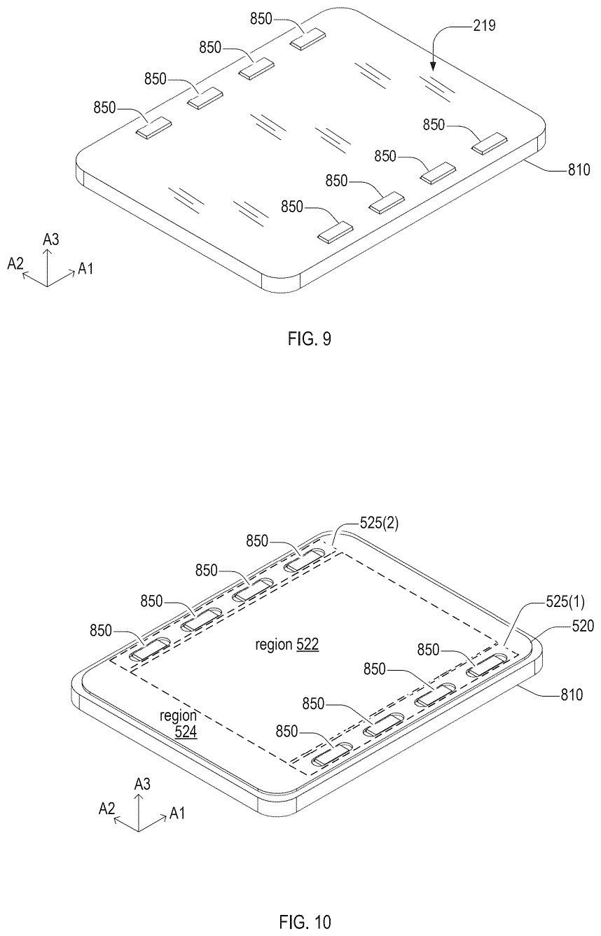

FIG. 8A is a schematic of an LCOS device 800, which is an embodiment of LCOS device 100. FIG. 8B is a plan view of LCOS device 800 that denotes cross-sectional planes 8a-8a′ and 8b-8b′, each of which is parallel to the A1-A3 plane. FIG. 8C is a cross-sectional view of part of LCOS device 800 in either of cross-sectional planes 8a-8a′ and 8b-8b′. FIGS. 9 and 10 are schematics of selected components of LCOS device 800. FIGS. 8A, 8B, 8C, 9, and 10 are best viewed together in the following description.

LCOS device 800 includes a substrate 810, a thermally-conductive layer 820, and at least one heating element 850, which are respective examples of substrate 110, thermally-conductive layer 120, and heating element 150 of LCOS device 100. LCOS device 800 also includes printed circuit layer 540 and LCOS display panel 230. The cross-sectional view of FIG. 8C includes part of LCOS device 800 that includes a heating element 850.

FIG. 8A does not illustrate heating elements 850, as in the example of FIG. 8A, heating elements 850 are covered by printed circuit layer 540. Without departing from the scope hereof, circuit layer 540 may include apertures that expose part of heating elements 850. Since FIG. 8B is a plan view, heating elements 850 are not visible FIG. 8B. However, for illustrative purposes, the locations of heating elements 850 are shown as dashed boxes. For clarity of illustration, not all heating elements 850 are labeled in FIG. 8B. While FIG. 8B denotes eight heating elements 850, LCOS device 800 may include a different number of heating elements 850 without departing from the scope hereof.

Substrate 810 has a top surface 819, a bottom surface 811 opposite top surface 819, and includes one or more blind holes 812, as shown in FIG. 8C. At least one of surfaces 811 and 819 is parallel to the A1-A2 plane. Top surface 819 is an example of top surface 519. In embodiments, heating element 850 and thermally-conductive layer 520 (region 524) are the same side of printed circuit layer 540, as shown in FIG. 8C.

Thermally-conductive layer 520 is on top surface 819. Blind hole 812 is at least partially covered by printed circuit layer-surface region 542 of printed circuit layer 540. At least part of heating element 850 being within blind hole 812 and is electrically connected to printed circuit layer 540 at the printed circuit layer-surface region 542. Top surface 819 includes a recess region 818, shown in FIG. 8C, that defines blind hole 812. LCOS device 800 may include, in each blind hole 812, thermally conductive fill 270, that thermally couples heating element 850 to thermally-conductive layer 520. In FIG. 8C, a section of conductive fill 270 is cut away to indicate blind hole 812 in FIG. 8C.

### Combinations of Features

Features described above, as well as those claimed below, may be combined in various ways without departing from the scope hereof. The following enumerated examples illustrate some possible, non-limiting combinations.

Embodiment 1. A liquid-crystal-on-silicon device comprising: a substrate; a thermally-conductive layer on the substrate and having a thermally-conductive central region surrounded by a thermally-conductive periphery region; an LCOS display panel on the thermally-conductive central region; a printed circuit layer on the thermally-conductive periphery region and at least partially surrounding the LCOS display panel; and a resistive heating element electrically connected to the printed circuit layer, thermally connected to the thermally-conductive periphery region, and at least part of the resistive heating element being directly above or directly below the thermally-conductive periphery region.

Embodiment 2. The device of embodiment 1, the thermally-conductive layer being on a top surface of the substrate; in a cross-sectional plane perpendicular to the top surface and intersecting the resistive heating element and the thermally-conductive layer, the resistive heating element and the thermally-conductive layer are on opposite sides of the printed circuit layer.

Embodiment 3. The device of either one of embodiments 1 or 2, the thermally-conductive layer being on a top surface of the substrate; in a cross-sectional plane perpendicular to the top surface and intersecting the resistive heating element and the thermally-conductive layer, the resistive heating element and the thermally-conductive layer are on a same side of the printed circuit layer.

Embodiment 4. The device of any one of embodiments 1-3, the resistive heating element being most proximate to a first part of the thermally-conductive periphery region adjacent to a first lateral surface of the LCOS display panel, and the device further comprising: an additional resistive heating element that is (i) electrically connected to the printed circuit layer, (ii) thermally connected to the thermally-conductive periphery region, and (iii) being most proximate to a second part of the thermally-conductive periphery region adjacent to a second lateral surface of the LCOS display panel that differs from the first lateral surface.

Embodiment 5. The device of any one of embodiments 1-4, further comprising: an additional resistive heating element that is (i) electrically connected to the printed circuit layer, (ii) thermally connected to the thermally-conductive periphery region, and (iii) adjacent to the resistive heating element; each of the resistive heating element and the additional resistive heating element being most proximate to a first part of the thermally-conductive periphery region adjacent to a first lateral surface of the LCOS display panel.

Embodiment 6. The device of any one of embodiments 1-5, the resistive heating element being most proximate to a first part of the thermally-conductive periphery region adjacent to a first lateral surface of the LCOS display panel, the first lateral surface being opposite a second lateral surface of the LCOS display panel; the printed circuit layer including a plurality of address electrodes arrayed in a first array-direction that is nonparallel to the first and the second lateral surfaces; the LCOS display panel including a plurality of bond pads arrayed along a second array-direction that is nonparallel to the first and the second lateral surfaces.

Embodiment 7. The device of any one of embodiments 1-6, the resistive heating element being surface mounted to the printed circuit layer.

Embodiment 8. The device of any one of embodiments 1-7, the printed circuit layer and the thermally-conductive layer being between the resistive heating element and the substrate.

Embodiment 9. The device of embodiment 8, the resistive heating element and the LCOS panel being on a same side of the substrate.

Embodiment 10. The device of any one of embodiments 1-9, the substrate including an aperture, the printed circuit layer having a printed circuit layer-surface region that is exposed through the aperture; at last part of the resistive heating element being within the aperture and being electrically connected to the printed circuit layer at the printed circuit layer-surface region.

Embodiment 11. The device of embodiment 10, further comprising, in the aperture, a thermally conductive material, that thermally couples the resistive heating element to the thermally-conductive layer.

Embodiment 12. The device of any one of embodiments 1-11, the thermally-conductive layer being on a top substrate-surface of the substrate, the top substrate-surface including a blind hole that is at least partially covered by a printed circuit layer-surface region of the printed circuit layer; at last part of the resistive heating element being within the blind hole and being electrically connected to the printed circuit layer at the printed circuit layer-surface region.

Embodiment 13. The device of embodiment 12, further comprising, in the blind hole, a thermally conductive material, that thermally couples the resistive heating element to the thermally-conductive layer.

Embodiment 14. The device of any one of embodiments 1-13, a material composition of the thermally-conductive layer including graphene.

Embodiment 15. The device of any one of embodiments 1-14, the thermally-conductive layer having a thermal conductivity exceeding 1 W/mK.

Embodiment 16. The device of any one of embodiments 1-15, a thickness of the thermally-conductive layer being between ten micrometers and one hundred micrometers.

Embodiment 17. The device of any one of embodiments 1-16, the thermally-conductive layer being one of a thermal paste, a thermal adhesive, a thermally conducive pad, a phase-change material, and a metal thermal interface material.

Embodiment 18. The device of any one of embodiments 1-17, a material composition of the substrate including one or more of aluminum nitride, aluminum oxide, stainless steel, aluminum, copper, or any combination thereof.

Embodiment 19. The device of any one of embodiments 1-18, the printed circuit layer being a flexible printed circuit layer.

Embodiment 20. The device of any one of embodiments 1-19, the resistive heating element being a positive-temperature-coefficient thermistor.

Changes may be made in the above methods and systems without departing from the scope of the present embodiments. It should thus be noted that the matter contained in the above description or shown in the accompanying drawings should be interpreted as illustrative and not in a limiting sense. Herein, and unless otherwise indicated the phrase “in embodiments” is equivalent to the phrase “in certain embodiments,” and does not refer to all embodiments.

As used in this specification, any appendices thereto, and the appended claims, the singular forms “a,” “an,” and “the” include plural referents unless the content clearly dictates otherwise. It should also be noted that the term “or” is generally employed in its non-exclusive sense, e.g., including “and/or,” unless the content clearly dictates otherwise. Regarding instances of the terms “and/or” and “at least one of,” for example, in the cases of “A and/or B,” “at least one of A and B,” and “at least one of A or B,” such phrasing encompasses the selection of (i) A only, or (ii) B only, or (iii) both A and B. In the cases of “A, B, and/or C, ” “at least one of A, B, and C,” and “at least one of A, B, or C,” such phrasing encompasses the selection of (i) A only, or (ii) B only, or (iii) C only, or (iv) A and B only, or (v) A and C only, or (vi) B and C only, or (vii) each of A and B and C. This may be extended for as many items as are listed.

The following claims are intended to cover all generic and specific features described herein, as well as all statements of the scope of the present method and system, which, as a matter of language, might be said to fall therebetween.

We claim:

1. A liquid-crystal-on-silicon device comprising:
a substrate;
a thermally-conductive layer on the substrate and having a thermally-conductive central region surrounded by a thermally-conductive periphery region;
an LCOS display panel on the thermally-conductive central region;
a printed circuit layer on the thermally-conductive periphery region and at least partially surrounding the LCOS display panel; and
a resistive heating element electrically connected to the printed circuit layer, thermally connected to the thermally-conductive periphery region, and at least part of the resistive heating element being directly above or directly below the thermally-conductive periphery region.

2. The device of claim 1,
the thermally-conductive layer being on a top surface of the substrate;
in a cross-sectional plane perpendicular to the top surface and intersecting the resistive heating element and the thermally-conductive layer, the resistive heating element and the thermally-conductive layer are on opposite sides of the printed circuit layer.

3. The device of claim 1,
the thermally-conductive layer being on a top surface of the substrate;
in a cross-sectional plane perpendicular to the top surface and intersecting the resistive heating element and the thermally-conductive layer, the resistive heating element and the thermally-conductive layer are on a same side of the printed circuit layer.

4. The device of claim 1, the resistive heating element being most proximate to a first part of the thermally-conductive periphery region adjacent to a first lateral surface of the LCOS display panel, and the device further comprising:
an additional resistive heating element that is (i) electrically connected to the printed circuit layer, (ii) thermally connected to the thermally-conductive periphery region, and (iii) being most proximate to a second part of the thermally-conductive periphery region adjacent to a second lateral surface of the LCOS display panel that differs from the first lateral surface.

5. The device of claim 1, further comprising:
an additional resistive heating element that is (i) electrically connected to the printed circuit layer, (ii) thermally connected to the thermally-conductive periphery region, and (iii) adjacent to the resistive heating element;
each of the resistive heating element and the additional resistive heating element being most proximate to a first part of the thermally-conductive periphery region adjacent to a first lateral surface of the LCOS display panel.

6. The device of claim 1, the resistive heating element being most proximate to a first part of the thermally-conductive periphery region adjacent to a first lateral surface of the LCOS display panel,
the first lateral surface being opposite a second lateral surface of the LCOS display panel;
the printed circuit layer including a plurality of address electrodes arrayed in a first array-direction that is nonparallel to the first and the second lateral surfaces;
the LCOS display panel including a plurality of bond pads arrayed along a second array-direction that is nonparallel to the first and the second lateral surfaces.

7. The device of claim 1, the resistive heating element being surface mounted to the printed circuit layer.

8. The device of claim 1, the printed circuit layer and the thermally-conductive layer being between the resistive heating element and the substrate.

9. The device of claim 8, the resistive heating element and the LCOS panel being on a same side of the substrate.

10. The device of claim 1,
the substrate including an aperture, the printed circuit layer having a printed circuit layer-surface region that is exposed through the aperture;
at last part of the resistive heating element being within the aperture and being electrically connected to the printed circuit layer at the printed circuit layer-surface region.

11. The device of claim 10, further comprising, in the aperture, a thermally conductive material, that thermally couples the resistive heating element to the thermally-conductive layer.

12. The device of claim 1,
the thermally-conductive layer being on a top substrate-surface of the substrate,
the top substrate-surface including a blind hole that is at least partially covered by a printed circuit layer-surface region of the printed circuit layer;
at last part of the resistive heating element being within the blind hole and being electrically connected to the printed circuit layer at the printed circuit layer-surface region.

13. The device of claim 12, further comprising, in the blind hole, a thermally conductive material, that thermally couples the resistive heating element to the thermally-conductive layer.

14. The device of claim 1, a material composition of the thermally-conductive layer including graphene.

15. The device of claim 1, the thermally-conductive layer having a thermal conductivity exceeding 1 W/mK.

16. The device of claim 1, a thickness of the thermally-conductive layer being between ten micrometers and one hundred micrometers.

17. The device of claim 1, the thermally-conductive layer being one of a thermal paste, a thermal adhesive, a thermally conducive pad, a phase-change material, and a metal thermal interface material.

18. The device of claim 1, a material composition of the substrate including one or more of aluminum nitride, aluminum oxide, stainless steel, aluminum, copper, or any combination thereof.

19. The device of claim 1, the printed circuit layer being a flexible printed circuit layer.

20. The device of claim 1, the resistive heating element being a positive-temperature-coefficient thermistor.
